(19) United States
(12) Patent Application Publication
(10) Pub. No.: US 2013/0095385 A1
(43) Pub. Date: Apr. 18, 2013

(54) CARBON-CONTAINING COMPOSITE MATERIAL CONTAINING AN OXYGEN-CONTAINING LITHIUM TRANSITION METAL COMPOUND

(71) Applicants: Nicolas Tran, Nandlstadt (DE); Christian Vogler, Moosburg (DE); Peter Bauer, Buch am Erlbach (DE)

(72) Inventors: Nicolas Tran, Nandlstadt (DE); Christian Vogler, Moosburg (DE); Peter Bauer, Buch am Erlbach (DE)

(73) Assignee: Sued-Chemie IP GmbH & Co. KG, Munich (DE)

(21) Appl. No.: 13/642,873

(22) PCT Filed: Apr. 14, 2011
(86) PCT No.: PCT/EP2011/055899

§ 371 Date: Dec. 13, 2012

(30) Foreign Application Priority Data
Apr. 23, 2010 (DE) 102010018041.6

(51) Int. Cl. H01M 4/36; H01M 4/485

(52) U.S. Cl. CPC H01M 4/366; H01M 4/485; B82Y 30/00
USPC 429/221; 429/231.1; 429/231.3; 429/224; 429/223; 427/122; 977/755

(57) ABSTRACT

The present invention relates to a carbon-containing composite material of particles of an oxygen-containing lithium transition metal compound which are coated with essentially two carbon-containing layers, a method for its production as well as an electrode containing the composite material.

### CROSS-REFERENCE TO RELATED APPLICATIONS

This application is a U.S. National Stage application claiming benefit of International Application No. PCT/EP2011/055899, filed Apr. 14, 2011, and claiming benefit of German Application No. DE 10 2010 018 041.6, filed Apr. 23, 2010. The entire disclosures of PCT/EP2011/055899 and DE 10 2010 018 041.6 are all incorporated herein by reference.

### BACKGROUND

The present invention relates to a carbon-containing composite material containing particles of an oxygen-containing lithium transition metal compound which are covered in areas with two carbon-containing layers. The present invention further relates to a method for producing the composite material as well as an electrode containing the composite material as active material.

Doped and non-doped mixed lithium transition metal compounds have recently received attention in particular as electrode materials in so-called (rechargeable) “secondary lithium-ion batteries”.

For example, non-doped or doped mixed lithium transition metal phosphates have been used as cathode material in secondary lithium-ion batteries since papers from Goodenough et al. (U.S. Pat. No. 5,910,382). To produce the lithium transition metal phosphates, both solid-state syntheses and also so-called hydrothermal syntheses from aqueous solution are proposed. Meanwhile, almost all metal and transition metal cations are known from the state of the art as doping cations.

Thus WO 02/099913 describes a method for producing LiMPO₄, wherein M, in addition to iron, is (are) one or more transition metal cation(s) of the first transition metal series of the periodic table of elements, in order to produce phase-pure optionally doped LiMPO₄.

EP 1 195 838 A2 describes the production of lithium transition metal phosphates, in particular LiFePO₄, by means of a solid-state process, wherein typically lithium phosphate and iron (II) phosphate are mixed and sintered at temperatures of approximately 600° C.

Further methods for producing in particular lithium iron phosphate have been described for example in Journal of Power Sources 119 to 121 (2003) 247 to 251, JP 2002-151082 A as well as in DE 103 53 266.

The thus-obtained doped or non-doped lithium transition metal phosphate is usually supplemented by added conductive agent such as conductive carbon black and processed to cathode formulations. Thus EP 1 193 784, EP 1 193 785 as well as EP 1 193 786 describe so-called carbon composite materials of LiFePO₄ and amorphous carbon which, when producing iron phosphate from iron sulphate, sodium hydrogen phosphate, also serves as reductant for residual Fe³⁺ residues in the iron sulphate as well as to prevent the oxidation of Fe²⁺ to Fe³⁺.

The addition of carbon is also intended to increase the conductivity of the lithium iron phosphate active material in the cathode. Thus in particular EP 1 193 786 indicates that not less than 3 wt.-% carbon must be contained in the lithium iron phosphate carbon composite material in order to achieve the necessary capacity and corresponding cycle characteristics of the material.

EP 1 049 182 B1 proposes to solve similar problems by coating lithium iron phosphate with a layer of amorphous carbon.

A disadvantage with the lithium transition metal phosphates of the state of the art is furthermore their inability to resist moisture as well as the so-called “soaking”, i.e. the transition metal of the electrode active material dissolves in the (liquid) electrolyte of a secondary lithium-ion battery and thereby reduces its capacity and voltage.

The use of doped and non-doped lithium titanates, in particular lithium titanate Li₄Ti₅O₁₂ (lithium titanium spinel) in rechargeable lithium-ion batteries has been described for some time as a substitute for graphite as anode material. A current overview of anode materials in lithium-ion batteries can be found e.g. in: Bruce et al., Angew. Chem. Int. Ed. 2008, 47, 2930-2946.

The advantages of Li₄Ti₅O₁₂ compared with graphite are in particular its better cycle stability, its better thermal load capacity as well as the higher operational reliability. Li₄Ti₅O₁₂ has a relatively constant potential difference of 1.55 V compared with lithium and achieves several 1000 charge and discharge cycles with a loss of capacity of <20%. Lithium titanate thus displays a clearly more positive potential than graphite.

However, the higher potential also results in a smaller voltage difference. Together with a reduced capacity of 175 mAh/g compared with 372 mAh/g (theoretical value) of graphite, this leads to a clearly lower energy density compared with lithium-ion batteries with graphite anodes.

However, Li₄Ti₅O₁₂ has a long life and is non-toxic and is therefore also not to be classified as posing a threat to the environment.

Various aspects of the production of lithium titanate Li₄Ti₅O₁₂ are described in detail. Usually, Li₄Ti₅O₁₂ is obtained by means of a solid-state reaction between a titanium compound, typically TiO₂, and a lithium compound, typically Li₂CO₃, at high temperatures of over 750° C. (U.S. Pat. No. 5,545,468). This high-temperature calcining step appears to be necessary in order to obtain relatively pure, satisfactorily crystallizable Li₄Ti₅O₁₂, but this brings with it the disadvantage that excessively coarse primary particles are obtained and a partial fusion of the material occurs. Typically, the high temperatures also often give rise to by-products, such as rutile or residues of anatase, which remain in the product (EP 1 722 439 A1).

Sol-gel methods for the production of Li₄Ti₅O₁₂ are also described (DE 103 19 464 A1), and also production methods by means of flame spray pyrolysis (Ernst, F. O. et al. Materials Chemistry and Physics 2007, 101 (2-3) pp. 372-378) as well as so-called “hydrothermal methods” in anhydrous media (Kalbac, M. et al., Journal of Solid State Electrochemistry 2003, 8 (1) pp. 2-6).

As already said above, doped and non-doped LiFePO₄ has recently been used as cathode material in lithium-ion batteries, with the result that a voltage difference of 2 V can be achieved in a combination of Li₄Ti₅O₁₂ and LiFePO₄.

High requirements apply for the rechargeable lithium-ion batteries provided for use today in particular also in cars, in particular in relation to their discharge cycles as well as their capacity. However, the materials or material mixtures of the electrode active materials proposed thus far, both for the cathode and for the anode, have yet to achieve the required electrode density, as they do not display the requisite compressed powder density. The powder density can be correlated approximately to the electrode density or the density of the so-called electrode active material and likewise also the battery capacity. The higher the compressed powder density of the active material(s) of the electrode(s) is, then the higher the volumetric capacity of the battery is also.

A disadvantage with many of the electrode materials used until now is—as already explained briefly above—also their sensitivity to moisture and their sometimes pronounced solubility in the electrolytes used, which most often contain lithium fluorine compounds such as LiPF₆, LiBF₄, etc.

### DESCRIPTION

The object of the present invention was therefore to provide an improved electrode active material for secondary lithium-ion batteries which, compared with the materials of the state of the art, has in particular an improved compressed density, increased resistance to moisture and a low solubility in secondary lithium-ion batteries in electrolytes.

This object of the present invention is achieved by a carbon-containing composite material containing particles of an oxygen-containing lithium transition metal compound which are covered in areas with two carbon-containing layers.

Surprisingly, the composite material according to the invention has compressed densities which, compared with the usual electrode materials of the state of the art, display an improvement of at least 5%, in preferred embodiments more than 10% compared with a material according to EP 1 049 182 B1.

By increasing the compressed density, a higher electrode density is thus also achieved when the composite material according to the invention is used as active material of the electrode, with the result that the volumetric capacity of a secondary lithium-ion battery is also increased by at least a factor of 5% using the composite material according to the invention as active material in the cathode and/or in the anode of a secondary lithium-ion battery compared with a material for example according to the above-named EP 1 049 182 B1.

In developments of the invention, the composite material consists exclusively of the particles, covered with two carbon-containing layers, of an oxygen-containing lithium transition metal compound.

Surprisingly, an electrode containing the composite material according to the invention also has a higher electric conductivity than an electrode containing a lithium transition metal compound provided with only a single carbon-containing layer as active material. The BET surface area of the composite material according to the invention also surprisingly decreases compared with lithium transition metal compounds coated once with carbon or not coated, whereby less binder is needed when producing electrodes.

Because of the essentially two carbon-containing layers of the composite material, an increased resistance to moisture, in particular air humidity, and to the “soaking” explained further above is achieved which is clearly increased compared with a material with a coating of only a single carbon-containing layer such as is disclosed e.g. in the EP 1 049 182 B1 already mentioned above. In particular, the composite material according to the invention is also very resistant to strong acids (see experimental part). The discharge of the transition metal (i.e. its solubility) into the (liquid) electrolyte used of a secondary battery is also clearly reduced compared with material coated once or not at all.

The “single coating” obtained according to the above patent EP 1 049 182 B1 is porous and often does not completely cover the particles of the lithium transition metal compound, which therefore leads in particular with the moisture-sensitive lithium transition metal phosphates to a partial decomposition and increased solubility of the transition metal e.g. in an acid or in the liquid electrolyte.

The term “carbon-containing” is here understood to mean a pyrolytically obtained carbon material which forms by thermal decomposition of suitable precursor compounds. This carbon-containing material can also be described synonymously by the term “pyrolytic carbon”.

The term “pyrolytic carbon” thus describes a preferably amorphous material of non-crystalline carbon. The pyrolytic carbon is, as already said, obtained from suitable precursor compounds by heating, i.e. by pyrolysis at temperatures of less than 1500° C., preferably less than 1200° C. and further preferably of less than 1000° C. and most preferably of ≦850° C., further of ≦800° C. and preferably ≦750° C.

At higher temperatures of in particular >1000° C. an agglomeration of the particles of the preferred oxygen-containing lithium transition metal compound due to so-called “fusion” often occurs, which typically leads to a poor current-carrying capacity of the composite material according to the invention. It is important according to the invention in particular that a crystalline, ordered synthetic graphite does not form.

Typical precursor compounds for pyrolytic carbon are for example carbohydrates such as lactose, sucrose, glucose, starch, cellulose, glycols, polyglycols, polymers such as for example polystyrene-butadiene block copolymers, polyethylene, polypropylene, aromatic compounds such as benzene, anthracene, toluene, perylene as well as all other compounds known to a person skilled in the art as suitable per se for the purpose as well as combinations thereof. Particularly suitable mixtures are e.g. lactose and cellulose, all mixtures of sugars (carbohydrates) with each other. A mixture of a sugar such as lactose, sucrose, glucose, etc. and propanetriol is also preferred.

The precise temperature at which the precursor compound(s) can be decomposed, thus also the choice of the precursor compound, also depends on the (oxygen-containing) lithium transition metal compound to be coated, as e.g. lithium transition metal phosphates often already decompose to phosphides at temperatures around 800° C.

Either the layer of pyrolytic carbon can be deposited onto the particles of the oxygen-containing lithium transition metal compound by direct in-situ decomposition onto the particles brought into contact with the precursor compound of pyrolytic carbon, or the carbon-containing layers are deposited indirectly via the gas phase, because part of the precursor compound is first evaporated or sublimated and then decomposes. A coating by means of a combination of both decomposition (pyrolysis) processes is also possible according to the invention.

The term “two carbon-containing layers” also covers the possibility that, in some embodiments of the present invention, no discrete boundary surface between the two layers can be defined, which also depends in particular on the choice of the precursor compound for the pyrolytic carbon. However, even in the case of a “fuzzy” boundary surface, a difference in the solid-state structure of both layers can still be determined for example by SEM or TEM methods, which can possibly be explained, without being bound to a particular theory, by the structural differences in the substrate to be coated (the “base”): the first layer is deposited directly on the particles of the oxygen-containing lithium transition metal compound, the second on the first layer of pyrolytic carbon.

The structural differences in the two layers of pyrolytic carbon can also be further accentuated by the choice of the respective starting compound(s), by using a (or even several) different precursor compound for each layer for example. Thus, for example, the first layer can be obtained starting from lactose and the second from starch or cellulose, or conversely.

Of course, it is also possible in developments of the present invention to provide a composite material according to the invention with more than 2 carbon-containing layers, e.g. three, four or still more layers.

The concept used according to the invention of an oxygen-containing lithium transition metal compound here covers compounds with the generic formula LiMPO₄, vanadates with the generic formula LiMVO₄, corresponding plumbates, molybdates and niobates, wherein M typically represents at least one transition metal or mixtures thereof. In addition, “classic oxides”, such as mixed lithium transition metal oxides of the generic formula LiₓM_{y}O (0≦x, y≦1), are also understood by this term in the present case, wherein M is preferably a so-called “early transition metal” such as Ti, Zr or Sc, or also, albeit less preferably, a “late transition metal” such as Co, Ni, Mn, Fe, Cr and mixtures thereof, i.e. thus compounds such as LiCoO₂, LiNiO₂, LiMn₂O₄, LiNi₁₋ₓCoₓO₂, LiNi_{0.85}Co_{0.1}Al_{0.05}O₂, etc.

In preferred embodiments of the present invention, the oxygen-containing lithium transition metal compound is a lithium transition metal phosphate of the generic formula LiMPO₄, wherein M represents in particular Fe, Co, Ni, Mn or mixtures thereof.

The term “a lithium transition metal phosphate” means, within the framework of this invention, that the lithium transition metal phosphate is present both doped and non-doped.

“Non-doped” means that pure, in particular phase-pure, lithium transition metal phosphate is used. The transition metal M is, as already said above, preferably selected from the group consisting of Fe, Co, Mn or Ni, thus has the formulae LiFePO₄, LiCoPO₄, LiMnPO₄ or LiNiPO₄, or mixtures thereof. LiFePO₄ is quite particularly preferred.

By a doped lithium transition metal phosphate is meant a compound of the formula LiM′_{y}M″ₓPO₄, wherein preferably M″=Fe, Co, Ni or Mn, M′ is different from M″ and represents at least one metal cation from the group consisting of Co, Ni, Mn, Fe, Nb, Ti, Ru, Zr, B, Al, Zn, Mg, Ca, Cu, Cr or combinations thereof, but preferably represents Co, Ni, Mn, Fe, Ti, B, Al, Mg, Zn and Nb, x is a number <1 and >0.01 and y is a number >0.001 and <0.99. Typical preferred compounds are e.g. LiNb_{y}FeₓPO₄, LiMg_{y}FeₓPO₄ LiB_{y}FeₓPO₄ LiMn_{y}FeₓPO₄, LiCo_{y}FeₓPO₄, LiMn_{z}Co_{y}FeₓPO₄, LiMn_{0.80}Fe_{0.10}Zn_{0.10}PO₄, LiMn_{0.56}Fe_{0.33}Mg_{0.10}PO₄ with 0≦x, y, z≦1).

In still further preferred embodiments of the present invention, the oxygen-containing lithium transition metal compound is a lithium titanium oxide. Compared with secondary lithium-ion batteries of the state of the art which use e.g. lithium titanium oxides coated once with carbon according to EP 1 796 189 as anode, lithium titanium oxide coated twice according to the invention leads to a stability and cycle stability increased by a further approx. 10% when used as anode.

By the term “a lithium titanium oxide” are meant here all doped or non-doped lithium-titanium spinels (so-called “lithium titanates”) of the type Li₁₊ₓTi₂₋ₓO₄ with 0≦x≦⅓ of the spatial group Fd3m and generally also all mixed lithium titanium oxides of the generic formula LiₓTi_{y}O (0≦x, y≦1).

As already stated above, the lithium titanium oxide is doped in developments of the invention with at least one further metal, which, compared with non-doped material, again leads to a stability and cycle stability further increased by approx. 5% when the doped lithium titanium oxide is used as anode. In particular, this is achieved by the incorporation of additional metal ions, preferably Al, B, Mg, Ga, Fe, Co, Sc, Y, Mn, Ni, Cr, V, Sb, Bi or several of these ions, into the lattice structure.

The doped and non-doped lithium titanium spinels are preferably rutile-free.

The doping metal ions are preferably present in a quantity of from 0.05 to 3 wt.-%, preferably 1-3 wt.-%, relative to the total compound in the case of all the above-named oxygen-containing lithium transition metal compounds. The doping metal cations occupy the lattice positions of either the transition metal or the lithium.

Exceptions to this are mixed Fe, Co, Mn, Ni lithium phosphates which contain at least two of the above-named elements, in which larger quantities of doping metal cations may also be present, in an extreme case up to 50 wt.-%.

With a monomodal particle-size distribution, the D₁₀ value of the particles of the composite material according to the invention is preferably ≦0.25, the D₅₀ value preferably ≦0.75 and the D₉₀ value ≦2.7 μm.

As already said, a small particle size of the composite material according to the invention leads, when used as active material of an electrode in a secondary lithium-ion battery, to a higher current density and also to a better cycle stability.

The thickness of the first carbon-containing layer of the composite material is advantageously ≦5 nm, in preferred developments of the invention approx. 2-3 nm, that of the second layer ≦20 nm, preferably 1 to 7 nm. Overall, the total thickness of both layers thus lies in a range of from 3-25 nm, wherein the layer thickness can in particular be set in targeted manner by the starting concentration of precursor material, the precise temperature choice and duration of the heating.

In further embodiments of the present invention, the particles of the oxygen-containing lithium transition metal compound are completely enclosed in the two layers of carbon-containing material and are thus particularly insensitive to the action of moisture and acid attack and so-called “soaking”, i.e. the dissolution of the transition metal(s) of the composite materials according to the invention in the electrolyte. “Soaking” leads, as already said, to a reduction in the capacity and electrical capacity of an electrode containing the composite material according to the invention and thus leads to a shorter life and lower stability.

Compared with materials of the state of the art, the composite material according to the invention has an extremely low solubility in non-aqueous liquids which are used as electrolyte in secondary lithium-ion batteries, such as e.g. compared with a mixture of ethylene carbonate and dimethyl carbonate in which lithium fluorine salts such as LiPF₆ or LiBF₄ are dissolved. In relation to a liquid containing a lithium fluorine salt (e.g. a mixture of ethylene carbonate and dimethyl carbonate) containing 1000 ppm water, the iron solubility of a composite material according to the invention in which LiFePO₄ is used as oxygen-containing lithium transition metal compound is ≦85 mg/l, preferably ≦40 mg/l, more preferably ≦30 mg/l, measured by means of the reference test explained below. Values for uncoated lithium transition metal compounds are e.g. approx. 1750 mg/l for LiFePO₄, approx. 90 mg/l for comparison material obtained according to EP 1 049 182 B1. Similar values in the above-defined limits result for the other transition metals in such compounds.

In quite particularly preferred embodiments the BET surface area (determined according to DIN 66134) of the composite material according to the invention is ≦16 m²/g, quite particularly preferably ≦14 m²/g and most preferably ≦10 m²/g. Small BET surface areas have the advantage that the compressed density and thus the electrode density of an electrode with the composite material according to the invention as active material, consequently also the volumetric capacity and the life of a battery, is increased. Less binder is furthermore needed in the electrode formulation.

The material according to the invention has a high compressed density of >2.3 g/cm³, preferably in the range of from 2.3 to 3.3 g/cm³, still more preferably in the range of from >2.3 to 2.7 g/cm³. This is an improvement of approx. 8% compared with composite material with a single layer of carbon, e.g. obtained according to EP 1 049 182 B1.

The compressed density achieved according to the invention results in clearly higher electrode densities in an electrode containing the composite material according to the invention as active material than with materials of the state of the art, with the result that the volumetric capacity of a secondary lithium-ion battery also increases when such an electrode is used.

The powder resistance of the composite material according to the invention (see further below) is preferably <30 Ω/cm, whereby a secondary lithium-ion battery with an electrode containing the composite material according to the invention, lithium metal oxide particles, is also characterized by a particularly high current-carrying capacity.

The total carbon content of the composite material according to the invention (thus the sum of pyrolytic carbon of the first and the at least second carbon-containing layers) is preferably <2 wt.-% relative to the total mass of composite material, still more preferably <1.6 wt.-%.

In further embodiments of the invention the total carbon content is approximately 1.4±0.2 wt.-%.

The object of the present invention is further achieved by a method for producing a composite material according to the invention, comprising the steps of
a) providing an oxygen-containing lithium transition metal compound in particle form
b) adding a precursor compound of pyrolytic carbon and producing a mixture of the two components
c) reacting the mixture by heating,
d) adding a new precursor compound for pyrolytic carbon to the reacted mixture and producing a second mixture
e) reacting the second mixture by heating.

As already stated above, the oxygen-containing lithium transition metal compound for use in the method according to the invention can be present both doped and non-doped. All oxygen-containing lithium transition metal compounds described in more detail above can be used in the present method according to the invention.

According to the invention, it is also not important how the synthesis of the oxygen-containing lithium transition metal compound has been carried out before use in the method according to the invention; i.e. it can be obtained both within the framework of a solid-state synthesis or also within the framework of a so-called hydrothermal synthesis, or else via any further methods.

However, it has been shown that the use in particular of a lithium transition metal phosphate or a lithium titanate which has been obtained by a hydrothermal route is particularly preferred in the method according to the invention and in the composite material according to the invention, as this often has fewer impurities than one produced by solid-state synthesis.

As already mentioned above, almost all organic compounds which can be reacted to carbon under the reaction conditions of the method according to the invention are suitable as precursor compounds of pyrolytic carbon.

Within the framework of the method according to the invention, carbohydrates, such as lactose, sucrose, glucose, starch, gelatine, cellulose, glycols, polyglycols or mixtures thereof are preferably used in particular, quite particularly preferably lactose and/or cellulose, in addition polymers such as for example polystyrene-butadiene block copolymers, polyethylene, polypropylene, aromatic compounds such as benzene, anthracene, toluene, perylene as well as mixtures thereof and all further compounds known to a person skilled in the art as suitable per se for the purpose.

When using carbohydrates, these are used, in particular embodiments of the present invention, in the form of an aqueous solution or, in a particularly advantageous development of the present invention, water is then added after mixing the carbon with the oxygen-containing lithium transition metal compound and/or the elementary carbon, with the result that a slurry is obtained, the further processing of which is preferred in particular from production engineering and emission points of view compared with other method variants.

Other precursor materials such as for example benzene, toluene, naphthalene, polyethylene, polypropylene etc. can be used either directly as pure substance or in an organic solvent.

Typically, within the framework of the method according to the invention, a slurry is formed which is most often first dried at a temperature of from 100 to 400° C.

The dried mixture can optionally also be compacted. The compacting of the dry mixture itself can take place as mechanical compaction e.g. by means of a roll compactor or a tablet press, but can also take place as rolling, build-up or wet granulation or by means of any other technical method appearing suitable for the purpose to a person skilled in the art.

After the optional compacting of the mixture from step b), in particular the dried mixture, the mixture is quite particularly preferably sintered at ≦850° C., advantageously ≦800° C., still more preferably at ≦750° C., as already stated above in detail, wherein the sintering takes place preferably under protective gas atmosphere, e.g. under nitrogen, argon, etc. Under the chosen conditions no graphite forms from the precursor compounds for pyrolytic carbon, but a continuous layer of pyrolytic carbon which partly or completely covers the particles of the oxygen-containing lithium transition metal compound does.

Although pyrolytic carbon still forms from the precursor compound over a wide temperature range at higher sintering temperatures, the particle size of the product formed increases through caking, which brings with it the disadvantages described above.

Nitrogen is used as protective gas during the sintering or pyrolysis for production engineering reasons, but all other known protective gases such as for example argon etc., as well as mixtures thereof, can also be used. Technical-grade nitrogen with low oxygen contents can equally also be used. After heating, the obtained product can still be finely ground.

After the application of the first layer of pyrolytic carbon, the carbon content of the thus-obtained material is typically 1 to 1.5 wt.-% relative to its total weight.

The second layer is applied by a repetition of the steps described above, wherein as already said in some developments of the present invention the same starting compound can be used for the pyrolytic carbon or else a different precursor compound from the precursor compound used for the first layer.

The object of the present invention is further achieved by an electrode for a secondary lithium-ion battery with an active material which contains the composite material according to the invention. In further embodiments of the present invention, the active material of the electrode consists of a lithium transition metal oxide according to the invention. Further constituents are e.g. conductive carbon black or else corresponding oxygen-containing lithium transition metal compounds not coated with carbon, or provided only with one carbon layer. It is understood that mixtures of several different oxygen-containing lithium transition metal compounds, with or without carbon coating (one, two or more layers), can of course also be used according to the invention.

A higher electrode active material density in the electrode formulation is also achieved by the increased compressed density of the composite material according to the invention compared with oxygen-containing lithium transition metal compounds not coated or coated only once. Typical further constituents of an electrode according to the invention (or in the so-called electrode formulation) are, in addition to the active material, also conductive carbon blacks as well as a binder. According to the invention, however, it is even possible to obtain a usable electrode with active material containing or consisting of the composite material according to the invention without further added conductive agent (i.e. e.g. conductive carbon black).

Any binder known per se to a person skilled in the art can be used as binder, such as for example polytetrafluoroethylene (PTFE), polyvinylidene difluoride (PVDF), polyvinylidene difluoride hexafluoropropylene copolymers (PVDF-HFP), ethylene-propylene-diene terpolymers (EPDM), tetrafluoroethylene hexafluoropropylene copolymers, polyethylene oxides (PEO), polyacrylonitriles (PAN), polyacryl methacrylates (PMMA), carboxymethylcelluloses (CMC), and derivatives and mixtures thereof.

Within the framework of the present invention typical proportions of the individual constituents of the electrode material are preferably 90 parts by weight active material, e.g. of the composite material according to the invention, 5 parts by weight conductive carbon and 5 parts by weight binder. A different formulation likewise advantageous within the framework of the present invention consists of 90-96 parts by weight active material and 4-10 parts by weight binder.

The composite material according to the invention which already has carbon because of its coating makes it possible, if additional conductive agents such as conductive carbon are to be used in the electrode formulation, for their content to be clearly reduced compared with the electrodes of the state of the art which use uncoated oxygen-containing lithium transition metal compounds. This leads to an increase in the electrode density and thus also the volumetric capacity of an electrode according to the invention, as conductive agents such as carbon black usually have a low density.

The electrode according to the invention typically has a compressed density of >2.0 g/cm³, preferably >2.2 g/cm³, particularly preferably >2.4 g/cm³. The specific capacity of an electrode according to the invention is approx. 160 mA/g at a volumetric capacity of >352 mAh/cm³, more preferably >384 mAh/cm³ (measured against lithium metal).

Typical discharge capacities D/10 for an electrode according to the invention lie in the range of from 150-165 mAh/g, preferably from 160-165 mAh/g.

Depending on the nature of the oxygen-containing lithium transition metal compound of the composite material, the electrode functions either as anode (preferably in the case of doped or non-doped lithium titanium oxide, which certainly can be used in less preferred embodiments, again depending on the nature of the counterelectrode, as cathode) or as cathode (preferably in the case of doped or non-doped lithium transition metal phosphates).

The object of the present invention is further achieved by a secondary lithium-ion battery containing an electrode according to the invention as cathode and/or as anode, with the result that a battery with higher electrode density (or density of the active material) is obtained, which has a higher capacity than previously known secondary lithium-ion batteries which have electrodes with materials of the state of the art. The use of such lithium-ion batteries according to the invention is thus also possible in particular in cars with simultaneously smaller dimensions of the electrode or the battery as a whole.

In developments of the present invention, the secondary lithium-ion battery according to the invention contains two electrodes according to the invention, one of which comprises or consists of doped or non-doped lithium titanium oxide containing the composite material according to the invention as anode and the other comprises or consists of doped or non-doped lithium transition metal phosphate containing composite material according to the invention as cathode. Particularly preferred cathode/anode pairs are LiFePO₄//LiₓTi_{y}O with a single cell voltage of approx. 2.0 V, which is well suited as substitute for lead-acid cells or LiCo_{z}Mn_{y}FeₓPO₄//LiₓTi_{y}O (wherein x, y and z are as defined further above) with increased cell voltage and improved energy density.

The invention is explained in more detail below with the help of drawings and examples which are not to be understood as limiting the scope of the present invention.

### BRIEF DESCRIPTION OF THE DRAWINGS

FIG. 1 shows the graphs of the discharge cycles of electrodes containing a comparison material obtained according to EP 1 049 182 B1 (FIG. 1a) and an electrode containing CC-LiFePO₄ according to the invention as active material (FIG. 1b);

FIG. 2 is a TEM picture of a composite material according to the invention (CC-LiFePO₄);

FIG. 3 is a TEM picture of a detail of the carbon-containing layers from FIG. 2; and

FIGS. 4a and b are further TEM pictures of details of a composite material according to the invention (CC-LiFePO₄).

### EXAMPLES

### 1. Measurement Methods

The BET surface area was determined according to DIN 66134.

The particle-size distribution was determined according to DIN 66133 by means of laser granulometry with a Malvern Mastersizer 2000.

The compressed density and the powder resistance were determined simultaneously with a Mitsubishi MCP-PD51 tablet press with a Loresta-GP MCP-T610 resistance meter, which are installed in a glovebox charged with nitrogen to exclude the potentially disruptive effects of oxygen and moisture. The tablet press was hydraulically operated via a manual Enerpac PN80-APJ hydraulic press (max. 10,000 psi/700 bar).

A 4-g sample of material according to the invention was measured at the settings recommended by the manufacturer (7.5 kN).

The powder resistance is then calculated according to the following equation:

Powder resistance[Ω/cm]=resistance[Ω]×thickness[cm]×RCF

The RCF value is equipment-dependent and was given by the equipment for each sample.

The compressed density is calculated according to the following formula:

$$Compressed density ( g \text{/} {cm}^{3} ) = \frac{mass of the sample ( g )}{Π \times {r}^{2} ( {cm}^{2} ) \times thickness of the sample ( in cm )}$$

r=radius of the sample tablet

Customary error tolerances are 3% at most.

The TEM examinations were carried out on an FEI-Titan 80-300, wherein 0.1 g of a sample was dispersed in 10 ml ethanol by means of ultrasound and a drop of this suspension was applied to a Quantifoil metal lattice structure and dried in air before the start of the measurement.

### 2. Experimental:

### 2.1 Electrode Production

Standard electrode compositions contained 90 wt.-% active material, 5 wt.-% Super P carbon black and 5 wt.-% PVDF (polyvinylidene fluoride).

Slurries were produced by first producing a 10 wt.-% PVDF 21216 solution in NMP (N-methylpyrrolidone) with a conductive additive (Super P carbon black), which was then further diluted with NMP, and finally adding the respective active material. The resulting viscous suspension was deposited by means of a coating knife onto an aluminium foil which was dried under vacuum at 80° C. Discs with a diameter of 1.3 cm were cut out from this foil, weighed and rolled to approx. 25 μm. The thickness and the density of the electrodes were then measured. The electrodes were then dried overnight in vacuum at 120° C. in a Büchi dryer. Corresponding cells were then assembled in a glovebox under argon.

The measured potential window was 2.0 V-4.1 V (against Li⁺/Li). EC (ethylene carbonate):DMC (dimethylene carbonate) 1:1 (vol.) with 1M LiPF₆ was used as electrolyte.

### 2.2. Determination of the Capacity and Current-Carrying Capacity

The capacity and current-carrying capacity were measured with the standard electrode composition.

During these measurements, the charge rate (C) was set at C/10 for the first cycle and at 1C for all further cycles.

The discharge rate (D) was increased from D/10 to 20D, if necessary.

3. Production of LiFePO₄ with a Single Coating

LiFePO₄ covered with one carbon-containing layer (intermediate product) was produced according to EP 1 049 182 B1 by varying the quantity of lactose in order to determine the optimum quantity of carbon in the intermediate product. The corresponding values for the intermediate products produced are shown in Table 1:

TABLE 1
Variation of the quantity of carbon in the intermediate product

Sample number

| | 1 | 2 | 3 | 4 |
|---|---|---|---|---|
| C (wt.- %) | 2.05 | 1.70 | 1.44 | 1.14 |
| BET (g/cm²) | 13.4 | 12.8 | 12.5 | 11.4 |
| d10 (μm) | 0.19 | 0.19 | 0.20 | 0.21 |
| d50 (μm) | 0.45 | 0.46 | 0.46 | 0.56 |
| d90 (μm) | 2.43 | 2.13 | 1.96 | 2.03 |
| Powder resistance (Ω · cm) | 23 | 25 | 28 | 44 |
| Compressed density | 2.05 | 2.05 | 2.21 | 2.25 |
| (g/cm³) | | | | |

The values for the compressed density of the samples with lower carbon content (samples 3 and 4) are 10% higher than those with a carbon content of 2 wt.-%. Moreover, they have the smallest BET surface areas, which is, as already mentioned above, also an important parameter.

These parameters, and the fact that the total carbon content of the active material plays an important role in the performance data of an electrode according to the invention, lead to samples 3 and 4 being preferred as intermediate products. In other words, the values for the quantity of lactose, thus generally of the carbon precursor material, are also chosen such that the carbon content of the intermediate product preferably lies in the range of from 0.9 to 1.5 wt.-%, particularly preferably in the range of from 1.1 to 1.5 wt.-%.

### 4. Production of LiFePO₄ According to the Invention Coated Twice (CC-LiFePO₄)

The coating of the intermediate products, which all have a carbon content in the preferred range of from 1.1 to 1.5 wt.-%, with the second carbon-containing layer was carried out according to two different method variants:

Here, the intermediate products were mixed with the corresponding quantity of lactose in the dry state and subsequently sintered at 750° C. under nitrogen for 3 hours.

In other embodiments, lactose was dissolved in water and the intermediate product impregnated with it followed by drying overnight under vacuum at 105° C. and subsequent sintering at 750° C. under nitrogen for 3 hours.

The results are shown in Table 2:

TABLE 2
Physical data of the composite material according to
the invention

| | Comparison | | | | |
|---|---|---|---|---|---|
| | sample | | | | |
| | according | | | | |
| | to EP | Sample No. | | | |
| | 1 049 182 B1 | 1 | 2 | 3 | 4 |
| C total (wt.- %) | 1.1 | 1.43 | 1.50 | 1.44 | 1.43 |
| BET (g/cm²) | 11.3 | 9.5 | 9.2 | 9.3 | 9.4 |
| d₁₀ (μm) | 0.21 | 0.21 | 0.21 | 0.21 | 0.21 |
| d₅₀ (μm) | 0.77 | 0.70 | 0.92 | 0.63 | 0.63 |
| d₉₀ (μm) | 2.37 | 2.26 | 2.64 | 2.18 | 2.14 |
| Powder resistance | 45 | 6 | 4 | 5 | 5 |
| (Ω · cm) | | | | | |
| Compressed | 2.25 | 2.38 | 2.37 | 2.39 | 2.41 |
| density | | | | | |
| (g/cm³) | | | | | |
| Capacity at | | | | | |
| different | | | | | |
| discharge rates | | | | | |
| (mAh/g) | | | | | |
| D/10 | 162 | 160 | 161 | 162 | 162 |
| 1D | 153 | 155 | 151 | 149 | 145 |
| 3D | 145 | 148 | 143 | 138 | 133 |
| 5D | 140 | 141 | 138 | 132 | 127 |
| 10D | 130 | 125 | 129 | 120 | 116 |
| Electrode density | 2.03 | 2.4 | 2.4 | 2.4 | 2.4 |
| (g/cm³) | | | | | |
| Volumetric | 373 | 384 | 387 | 389 | 389 |
| capacity | | | | | |
| (mAh/cm³) | | | | | |

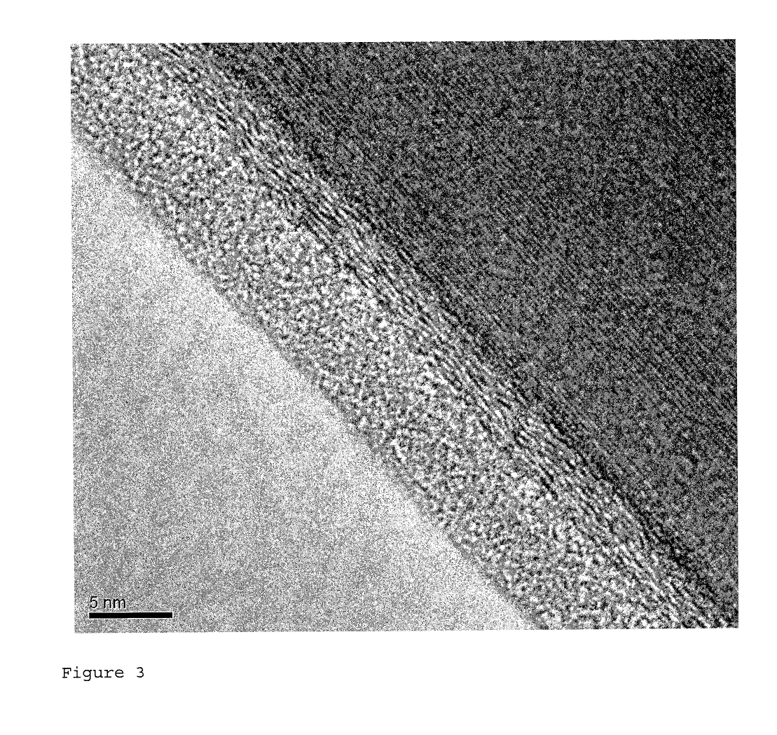

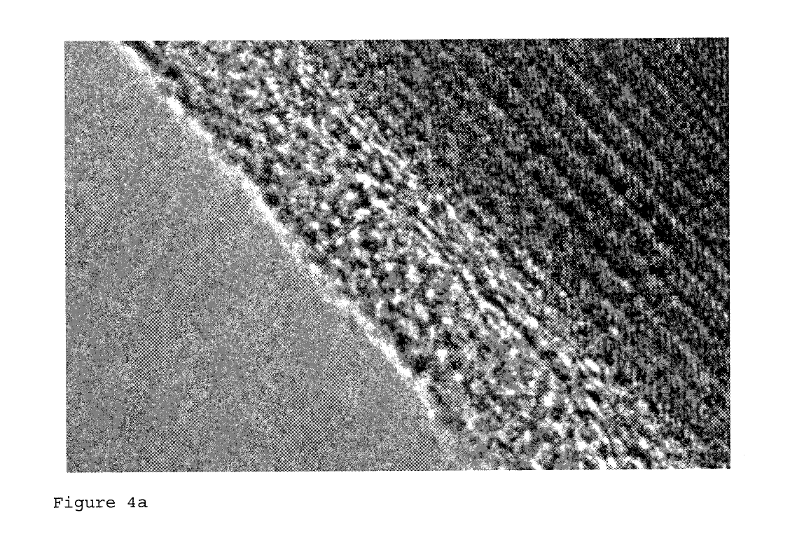

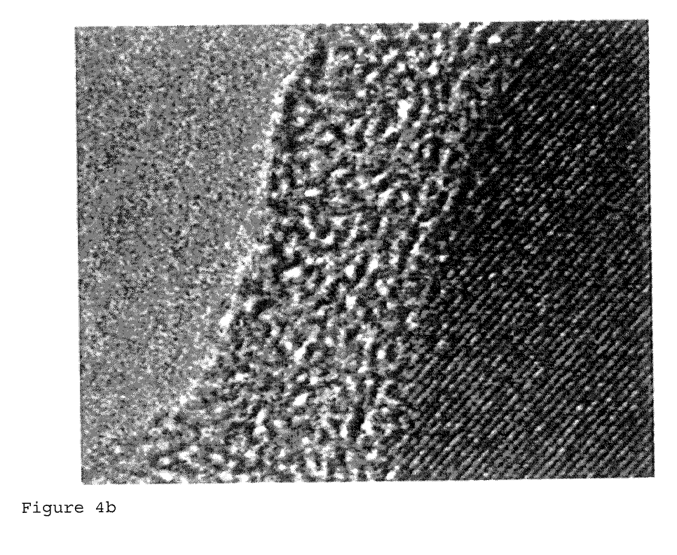

The samples were examined by means of TEM (FIG. 2). The carbon layers are represented in detail in FIGS. 3 and 4 which show the different layer structure of the carbon-containing layer.

The BET surface area of the CC-LiFePO₄ according to the invention lay in the range of from 9.5 m²/g to 9.4 m²/g. The values for the powder resistance were lower than with the comparison sample.

The values for the compressed density all lay in the range between 2.37 and 2.41 g/cm³, which represents an improvement of from 15 to 20% compared with the comparison sample, which has a value of 2.25 g/cm².

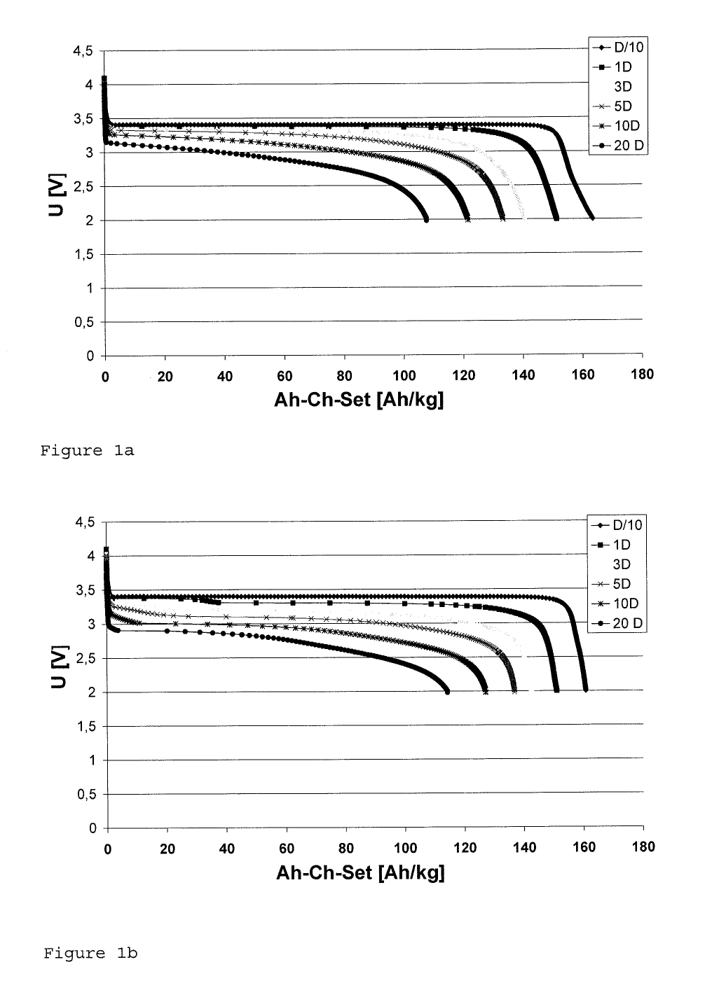

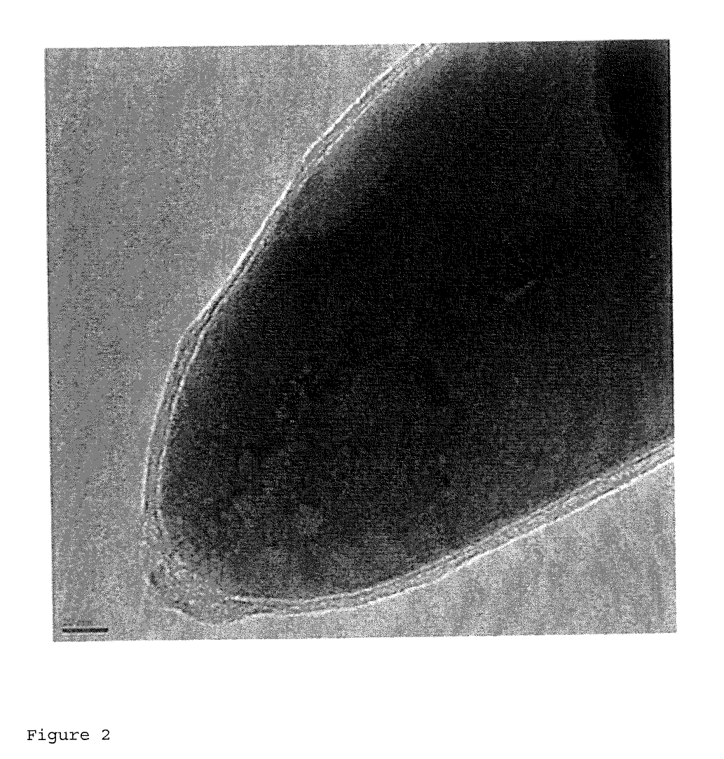

The discharge rate was typically approx. 160 mAh/g ±2% at D/10 and 122 mAh/g ±10% at 10D for all samples 1 to 4 according to the invention when used as active material in an electrode (FIG. 1b).

The results for the comparison sample were 160 mAh/g at D/10 and 123 mAh/g at 10D. (FIG. 1a).

### 5. Determination of the Density of the Active Material in an Electrode

To determine the material density of the active material, electrodes (thickness approx. 25 μm) composed of 90% active material, 5 wt.-% conductive carbon black and 5 wt.-% binder were produced.

For this, 2.0 g 10% PVDF solution in NMP (N-methylpyrrolidone), 5.4 g NMP, 0.20 g Super P Li conductive carbon black (Timcal), 3.6 g lithium iron phosphate particles according to the invention (2.2 wt.-% total carbon) as well as comparison material (see under section 4) with the same carbon content 1a as comparison were weighed into a 50-ml screw-lid jar and mixed for 5 minutes at 600 rpm, dispersed for 1 min with a Hielscher UP200S ultrasound finger and then, after adding 20 glass beads of 4 mm diameter and sealing the jar, rotated at a speed of 10 rpm on a roller table for at least 15 hours. To coat the electrode, the thus-obtained homogeneous suspension was applied to an aluminium carrier foil with a laboratory coating knife with a 150-μm gap width and a feed rate of 20 mm/sec. After drying at 80° C. in the vacuum drying cupboard, electrodes with a diameter of 13 mm were punched out of the foil and mechanically post-compacted to 25 μm at room temperature by means of a laboratory roller mill. To determine the density the net electrode weight was determined from the gross weight and the known unit weight of the carrier foil and the net electrode thickness determined with a micrometer screw less the known thickness of the carrier foil.

The active material density in g/cm³ in the electrode is calculated from

(active material portion in electrode formulation(90%)*electrode net weight in g/(π(0.65 cm)²*net electrode thickness in cm)

As value for the active material density in the electrode, 2.0 g/cm³ was found for LiFePO₄ (obtainable from Süd-Chemie AG), 2.3 g/cm³ for the comparison sample and for example 2.4 g/cm³ for the composite material according to the invention (see Table 2).

### 6. Acid Resistance Test

The tests vis-à-vis an acid attack were carried out on samples of uncoated LiFePO₄ (“Leifo” obtained according to WO 02/099913), with a single layer of carbon (coated according to EP 1049 182 B1, “C-Leifo”) and composite material according to the invention (“CC-Leifo”) each with different total carbon contents as follows:

5 g sample in powder form was made up to 95 ml with 1M HNO₃ solution, stirred for 5 min with a magnetic stirrer in a beaker, left to settle for 5 min and then centrifuged at 4000 rpm for 20 min. The supernatant was removed by filtration and the residue was dried overnight in a vacuum drying cupboard at 105° C. On the following day, the residue was weighed.

| | Weighed- | | | | |
|---|---|---|---|---|---|
| | in | | Yield | C content | |
| Sample | quantity | Yield | (%) | (%) | HNO₃ |
| CC-Leifo 1 | 5 g | 1.85 g | 37.0 | 2.2 | 1M |
| CC-Leifo 2 | 5 g | 1.53 g | 30.6 | 2.2 | 1M |
| C-Leifo 1 | 5 g | 1.32 g | 26.4 | 2.05 | 1M |
| C-Leifo 2 | 5 g | 1.1 g | 22.0 | 1.14 | 1M |
| CC-Leifo 3 | 5 g | 1.24 g | 25.0 | 1.43 | 1M |
| C-Leifo 3 | 5 g | 0.83 g | 20.0 | 1.1 | 1M |
| Leifo | 5 g | 0.40 g | 8 | 0 | 1M |

It is clear from the table that uncoated LiFePO₄ dissolves almost completely, the LiFePO₄ covered in areas with a carbon-containing layer dissolves less well and the composite material according to the invention the least well, i.e. is most resistant to an attack by concentrated acid.

### 7. Solubility Test

The solubility test (soaking) was carried out on LiFePO₄ coated once (C-leifo), LiFePO₄ coated twice (CC-Leifo) and uncoated LiFePO₄ (Leifo) as follows:

Flat bags (internal dimensions 4.0×10.0 cm, sealed on 3 sides) of aluminium composite foil A30 (d: 103 μm), Article-No. 34042, Nawrot AG were used.

First, the net weight of the aluminium composite foil bags (external dimensions 11 cm×6 cm) was determined (beam analytical balance) 0.8 g of the electrode material (90 wt.-% active material, 5% conductive carbon black, 5 wt.-% PVDF binder) is welded with 4 ml electrolyte (LiPF₆ (1M) in ethyl carbonate (EC)/dimethyl carbonate (DMC) 1:1, water content: 1000 ppm) into the aluminium bag (approx. 10 cm×6 cm) (bag 1) or sealed with 4 ml electrolyte (LiPF₆ (1M) in ethyl carbonate (EC)/dimethyl carbonate (DMC) 1:1 (without detectable traces of water) (bag 2) and then stored at 60° C. for 12 weeks. After expiry of the test time, the bags were re-weighed to determine any loss of electrolyte. 0.2 μl electrolyte were then analyzed by means of ICP-OES (Spectroflame Modula S).

The results were as follows:

| | | | | Dissolved | C |
|---|---|---|---|---|---|
| | | | Duration | Fe | content |
| Sample | Bag | T (° C.) | (weeks) | (mg/kg) | (wt. %) |
| Leifo | 1 | 60° C. | 12 | 1758 | 0 |
| | 2 | 60° C. | 12 | 0.1 | 0 |
| C-Leifo | 1 | 60° C. | 12 | 88 | 2.2 |
| | 2 | 60° C. | 12 | 0.07 | 2.2 |
| CC-Leifo 3 | 1 | 60° C. | 12 | 21 | 1.43 |
| | 2 | 60° C. | 12 | <0.06 | 1.43 |
| CC-Leifo 4 | 1 | 60° C. | 12 | 30 | 1.33 |
| | 2 | 60° C. | 12 | <0.06 | 1.33 |

As is clear from the table, the iron solubility in the case of composite material according to the invention (“CC-Leifo”) is clearly less than in the case of uncoated LiFePO₄ (Leifo) or in the case of LiFePO₄ coated once (C-Leifo).

1. Carbon-containing composite material containing particles of an oxygen-containing lithium transition metal compound which are covered in areas with two carbon-containing layers.

2. Composite material according to claim 1, wherein the lithium transition metal compound is a doped or a non-doped lithium transition metal phosphate and the transition metal is selected from the group consisting of Fe, Co, Mn or Ni or mixtures thereof.

3. Composite material according to claim 1, wherein the lithium transition metal compound is a doped or non-doped lithium titanium oxide.

4. Composite material according to claim 3, wherein the lithium titanium oxide is lithium titanate Li₄Ti₅O₁₂.

5. Composite material according to 1, wherein the carbon in each carbon-containing layer has a different structure in the solid.

6. Composite material according to claim 5, wherein the thickness of the first carbon-containing layer is ≦5 nm and the thickness of the second carbon-containing layer ≦2.0 nm.

7. Composite material according to claim 6, the BET surface area of which is ≦16 m²/g.

8. Composite material according to claim 7, the transition metal solubility of which in a liquid containing a lithium fluorine salt is ≦85 mg/l.

9. Composite material according to claim 8, the compressed density of which is >2.3 g/cm³.

10. Composite material according to claim 9, the powder resistance of which is <35 Ω/cm.

11. Composite material according to claim 10 with a total carbon content <1.6 wt.-%.

12. Method for producing a composite material according to one of the previous claims, comprising the steps of:
a) providing an oxygen-containing lithium transition metal compound in particle form;
b) adding a precursor compound of pyrolytic carbon and producing a mixture of the two components;
c) reacting the mixture by heating;
d) adding a new precursor compound of pyrolytic carbon to the reacted mixture and producing a second mixture; and
e) reacting the second mixture by heating.

13. Method according to claim 12, wherein a doped or non-doped lithium transition metal phosphate or a doped or non-doped lithium titanium oxide is used as oxygen-containing lithium transition metal compound.

14. Method according to claim 13, wherein a carbohydrate is used as precursor compound of pyrolytic carbon.

15. Method according to claim 14, wherein in step b) and/or d) the mixture is produced in the form of an aqueous mixture as slurry.

16. Method according to claim 12, wherein the heating in step c) and/or e) takes place at a temperature ≦850° C.

17. Oxygen-containing lithium transition metal compound coated twice with carbon, obtainable by a method according to claim 12.

18. Electrode for a secondary lithium-ion battery with an active material which contains a composite material according to claim 1.

19. Electrode according to claim 18 which is free of added conductive agent.

20. Secondary lithium-ion battery with an electrode according to claim 18.
